(19) United States
(12) Patent Application Publication
(10) Pub. No.: US 2013/0084377 A1
(43) Pub. Date: Apr. 4, 2013

(54) DOUGH TRAY AND METHOD OF DISTRIBUTING DOUGH

(71) Applicant: Michael Orris, Plymouth, MI (US)

(72) Inventor: Michael Orris, Plymouth, MI (US)

(21) Appl. No.: 13/251,806

(22) Filed: Oct. 3, 2011

(51) Int. Cl. A21D 10/02; B65D 85/00; A21D 6/00

(52) U.S. Cl. 426/503; 206/524.1

(57) ABSTRACT

A dough tray is provided for distributing dough. The dough tray includes a plurality of dough wells, a plurality of grooves defined by the dough wells, and a plurality of denesting features.

### FIELD

The invention relates to a dough carrier for distributing dough, and more particularly to a dough carrier having a plurality of wells for holding the dough.

### BACKGROUND

The statements in this section merely provide background information related to the present disclosure and may or may not constitute prior art.

Current dough ball distribution methods typically involve shaping individual portions of dough and carefully placing each dough ball in a precise location on a flat surface. Expensive equipment may be required to properly shape the dough balls and a time consuming templates may be used to place the dough in precise locations. In addition to the expense of the dough shaping equipment, a thin film of compacted dough may form on the outside of the dough ball due to the extensive handling. The film may trap air and form air pockets in the dough.

If the dough is oddly shaped or incorrectly placed, adjacent dough balls may contact each other during expansion of the dough due to yeast activity, or proofing. Such contact may make separation of individual dough balls difficult. Furthermore, the outward expansion of the dough restricts the number of dough balls that may be placed on any given surface.

Accordingly, there is a need for an improved dough carrier and method of distributing dough.

### SUMMARY

A dough carrier is provided having a plurality of dough wells and a top portion. The dough wells each have a side wall extending from the top portion and a bottom portion substantially parallel with the top portion. The side walls and the bottom portion define a truncated cone shaped cavity for containing dough.

In another example of the present invention, a dough carrier includes a polymeric main body and a plurality of frustoconical shaped dough wells formed in the main body. Each of the wells has an open end opposing a closed end. Each of the plurality of frustoconical shaped dough wells includes a bottom portion and a side wall. The bottom portion is substantially disk shaped and defines the closed end. The side wall extends between the bottom portion and the open end and tapers from a first diameter at the open end to a second diameter at the bottom portion that is less than the first diameter.

In yet another example of the present invention, the side wall defines grooves extending between the open end and the bottom portion of each of the plurality of frustoconical shaped dough wells.

In yet another example of the present invention, troughs of the grooves extend radially outward from the side walls and have a shape that is substantially a portion of a cone that has been cut along a plane from a base of the cone to a tip of the cone.

In yet another example of the present invention, the dough carrier further includes a plurality of denesting features.

In yet another example of the present invention, the denesting features include a plurality of ridges extending radially outward from the grooves and including a resting surface that is substantially parallel with the bottom portion and is facing away from the open end.

In yet another example of the present invention, the denesting features include a plurality of denesting lugs extending from the open end towards the bottom portion, wherein the denesting lugs each have a shape that is substantially a rectangular prism.

In yet another example of the present invention, the carrier is comprised of a single injection molded component.

In yet another example of the present invention, the side wall of each of the plurality of dough wells has a predetermined thickness that is preselected to exhibit minimal warping when exposed to hot water and to conduct heat at a rate that quickly reduce a temperature of the dough when the dough carrier is placed in a refrigerated environment.

In yet another example of the present invention, the main body is a vacuum formed tray disposed in an injection molded tub.

In yet another example of the present invention, the side walls include materials that inhibit adhesion with dough.

In yet another example of the present invention, the materials that inhibit adhesion include silicone that is included in a maximum amount considered safe for use with food.

In yet another example of the present invention, each of the plurality of dough wells is sized to contain a pizza dough ball when the pizza dough ball is substantially finished rising.

In yet another example of the present invention, the plurality of dough wells include eleven dough wells arranged in three staggered rows.

In yet another example of the present invention, the plurality of dough wells have a diameter to depth ratio of about 2.5:1.

In yet another example of the present invention, the main body further includes a pair of cutout handle portions defined at opposing ends of the main body.

In yet another example of the present invention, a method of distributing dough is provided. The method includes: providing a dough carrier having a plurality of wells for holding the dough; extruding the dough; separating the dough into a plurality of dough segments; inserting the plurality of dough segments into the plurality of wells of the dough carrier; cooling the dough segments; allowing the dough segments to rise to conform to the shape of the wells of the dough carrier; transporting the dough carrier; and removing the dough from the wells of the dough carrier.

In yet another example of the present invention, the method further includes filling additional dough carriers and stacking the dough carriers before transporting the dough carrier.

In yet another example of the present invention, providing the dough carrier further includes removing the dough carrier from a stack of nested dough carriers.

In yet another example of the present invention, inserting the plurality of dough segments into the plurality of wells of the dough carrier further includes inserting the plurality of dough segments into the plurality of wells of the dough carrier with minimal handling of the dough to minimize formation of a skin on the dough.

In yet another example of the present invention, providing a dough carrier further includes providing a dough carrier having a plurality of wells each having a plurality of grooves, and wherein cooling the dough segments further includes allowing cool air to travel through the grooves of the wells.

In yet another example of the present invention, transporting the dough carrier further includes transporting the dough carrier to a pizzeria.

In yet another example of the present invention, a system for transporting dough is provided. The system includes: a dough carrier having a plurality of wells for holding the dough; a dough extruder for extruding the dough; a dough separator for separating the dough into dough segments; a dough inserter to insert the plurality of dough segments into the plurality of wells of the dough carrier; a cooler for cooling the dough segments in the wells of the dough carrier; and a vehicle for transporting the dough carrier that contains the dough segments.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is an isometric view of a dough carrier in accordance with principles of an embodiment of the present invention;

FIG. 2A is an isometric view of a dough tray in accordance with principles of an embodiment of the present invention;

FIG. 2B is an expanded view of a portion of the dough tray of FIG. 2A in accordance with principles of an embodiment of the present invention;

FIG. 2C is a top view of the dough tray of FIG. 2A in accordance with principles of an embodiment of the present invention;

FIG. 3A is an isometric view of a dough tray in accordance with principles of an embodiment of the present invention;

FIG. 3B is a top view of the dough tray of FIG. 3A in accordance with principles of an embodiment of the present invention; and

FIG. 4 is a flow chart of a method in accordance with principles of an embodiment of the present invention.

### DETAILED DESCRIPTION

The following description is merely exemplary in nature and is not intended to limit the present disclosure, application, or uses.

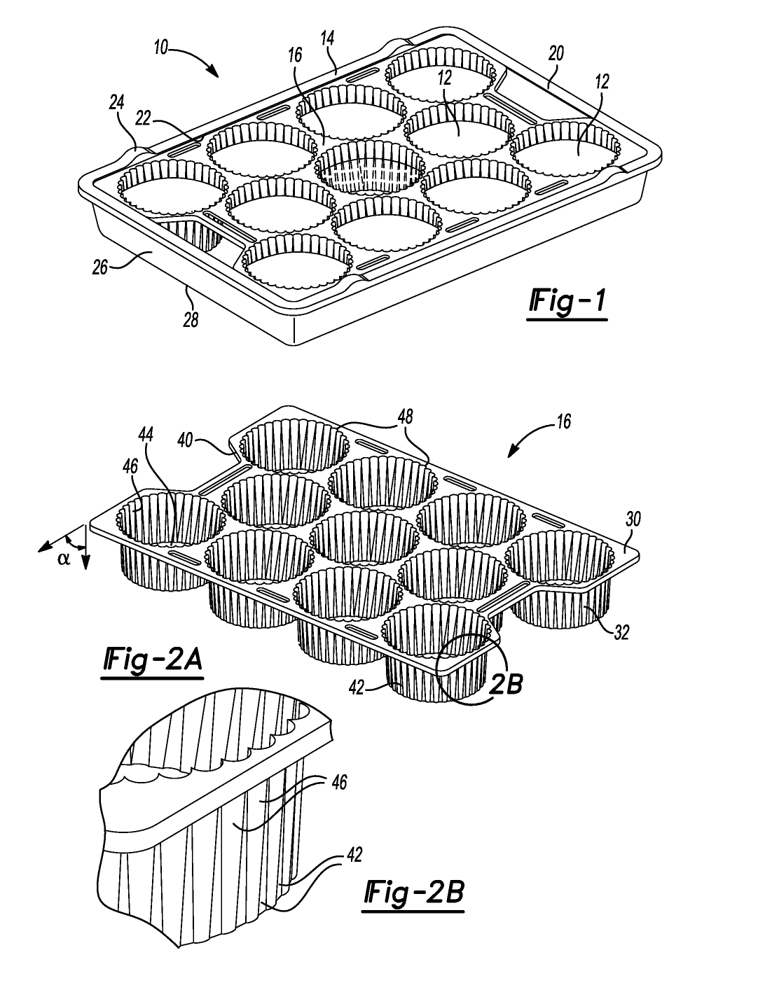

Referring to FIG. 1, a dough carrier 10 is illustrated holding a plurality of dough segments 12. In the example provided, the dough carrier 10 includes a tub 14 and a tray 16 disposed in the tub 14. In alternative embodiments the carrier 10 is a single piece having combined properties of the tub 14 and the tray 16. The tub 14 is generally rectangular in shape and includes a lip portion 20 and a cavity portion 22. The lip portion 20 includes a plurality of stacking ridges 24 extending from the lip portion 20 away from the cavity portion 22 to provide beneficial stacking attributes for the carrier 10. The cavity portion 22 is defined by four side walls 26 and a bottom portion 28. The side walls 26 extend from the lip portion 20 to the bottom portion 28. It should be appreciated that the size, shape, method of manufacture, and other attributes of the tub 14 may vary without departing from the scope of the present invention.

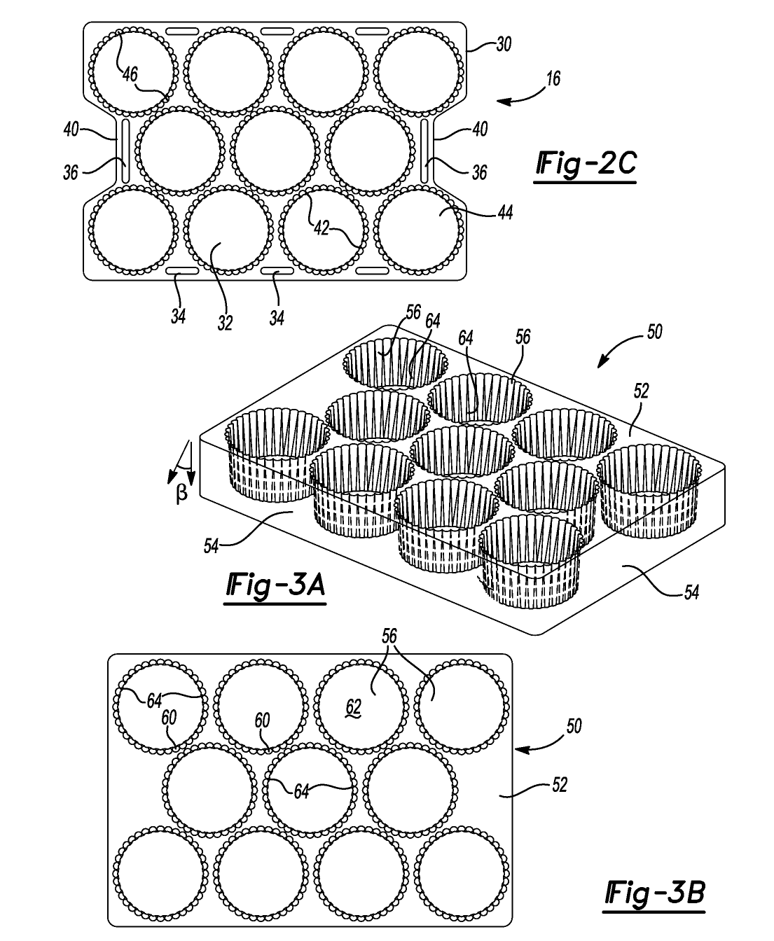

Referring now to FIGS. 2A, 2B, and 2C, and with continued reference to FIG. 1, the tray 16 is shown in isometric and top views. The tray 16 includes a main body with a top portion 30, a plurality of dough wells 32, a plurality of side lugs 34, and a plurality of end lugs 36. The top portion 30 is generally flat with a substantially rectangular shape. Open portions 40 or handles extend inward from an edge of the top portion 30.

The plurality of dough wells 32 are substantially shaped as truncated cones and include side walls 42 and bottom portions 44. The side walls 42 extend away from an open end at the top portion 30 at an angle α toward the bottom portions 44 or a closed end of the wells 32. In the example provided the angle α is about eighty three degrees. The side walls 42 define a plurality of grooves 46 extending between the top portion 30 and the bottom portion 44 around the circumference of the dough wells 32 to facilitate cooling of the dough segments 12. Each of the grooves 46 is tapered from a maximum width near the top portion 30 to a minimum width near the bottom portion 44. The grooves 46 provide beneficial cooling and denesting properties. A plurality of ridges 48 are defined by the side walls 42. The ridges 48 extend outward from the side walls 42 to provide a surface that will rest on the top surface 30 of an adjacent tray 16 when the trays 16 are stacked. The bottom portions 44 are substantially parallel with the top portion 30 and connect with the side walls 42 at a rounded interface.

In the example provided, eleven dough wells 32 are provided in three rows. The outer rows each include four wells 32 and the inner row has three wells 32 staggered with respect to the wells 32 in the outer rows. The inner row is substantially aligned with the open portions 40 of the top portion 30. The dough wells 32 are preferably sized and shaped to accommodate a single unit of dough. For example, the embodiment provided is sized and shaped to hold an amount of “proofed” dough that will make a large pizza, which is about 5.7 inches in diameter and about 2.3 inches deep for an about 2.5:1 diameter to depth ratio. As the dough segments 12 expand due to yeast activity, the dough wells 32 shape the dough segments 12 into desirable shapes for creating pizzas. It should be appreciated that the shape, size, and configuration of the tray 16 may vary without departing from the scope of the present invention.

The side lugs 34 project from the top portion 30 and are disposed between the dough wells 32 along an edge of the tray 16. The end lugs 36 project from the top portion 30 and are disposed between the open portions 40 and the dough wells 32 of the inner row of dough wells 32.

In the example provided the tray 16 is vacuum formed using a high silicone content material to reduce adhesion between the dough segments 12 and the tray 16. A high silicone content, for example, may be the highest content approved for use with food by the Food and Drug Administration. It should be appreciated that the manufacturing process and the material may be altered without departing from the scope of the present invention.

Referring now to FIGS. 3A and 3B, a dough carrier 50 is illustrated in isometric and top views. The dough carrier 50 is similar to the dough carrier 10, however the dough carrier 50 is an injection molded single component that integrates certain features from the tub 14 and the tray 16. The carrier 50 includes a top portion 52, side portions 54, and a plurality of dough wells 56. The top portion 52 is generally flat with a substantially rectangular shape. The side portions 54 are substantially perpendicular to the top portion 52 and are sized and shaped to support the weight of the dough carrier 50 when loaded with dough and stacked on other dough carriers 50.

The plurality of dough wells 56 are substantially shaped as truncated cones and include side walls 60 and bottom portions 62. The side walls 60 extend away from the top portion 30 at an angle β toward the bottom portions 62. In the example provided the angle β is about eighty three degrees. The side walls 60 define a plurality of grooves 64 extending between the top portion 52 and the bottom portion 62 around the circumference of the dough wells 56 to facilitate cooling of the dough segments. Each of the grooves 64 is tapered from a maximum width near the top portion 50 to a minimum width near the bottom portion 62. The grooves 64 provide beneficial cooling properties to reduce yeast activity of the dough. The bottom portions 62 are substantially parallel with the top portion 50 and connect with the side walls 60 at a rounded interface. The material and wall thickness of the side walls 60 are selected to balance the demands of the dough carrier 50. For example, the material and thickness are selected to reduce warping or deformation during hot water washing or cleaning yet have desirable heat transfer characteristics to allow the temperature of the dough to be lowered quickly for improved yeast activity characteristics.

It should be appreciated that other components of the tub 14 and tray 16 may be incorporated into the dough carrier 50. For example, the dough carrier 50 may include features similar to the lip 20 of the tub 14 and the lugs 34, 36 of the tray 16.

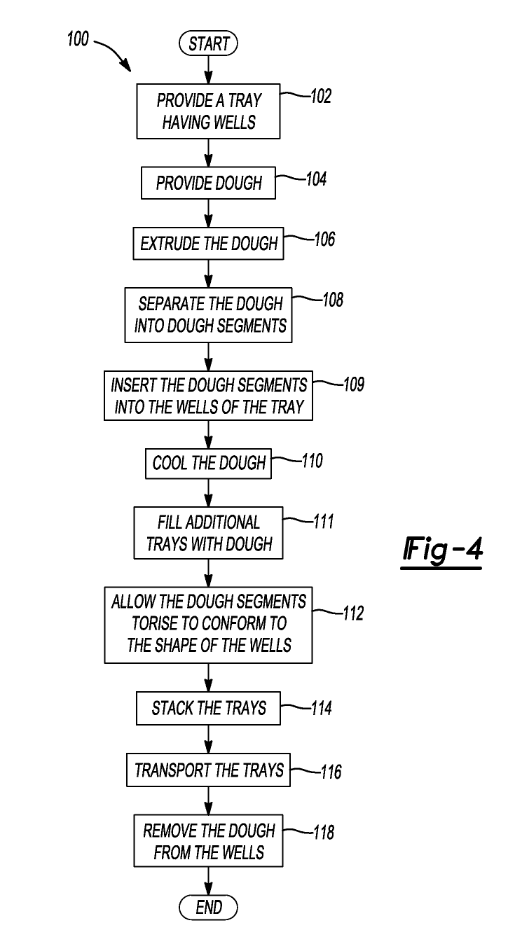

Referring now to FIG. 4, a method 100 of distributing dough is illustrated as a flow chart. The method starts at step 102 where a tray having dough wells is provided, such as the tray 16 or the dough carrier 50 described above. For example, a tray 16 may be quickly removed from a stack of trays 16 in part because the lugs 34, 36 allow air to flow between the trays to reduce sticking between the trays 16.

In step 104 dough is provided. For example, pizza dough may be provided. In step 106 the dough is extruded. In step 108 the dough is separated into dough segments. For example, the dough may be cut or lopped to create dough segments 12 such as described above for each creating a pizza.

In step 109 the dough segments are placed in the dough wells 32. Preferably steps 106, 108, and 109 are performed with minimal handling of the extruded dough and dough segments to minimize formation of a “skin” on the outside of the dough, which may trap air when cooking the pizza. In the example provided, the dough is extruded and cut directly into the dough wells 32.

The dough segments 12 are cooled in step 110. For example, in the embodiment shown the tray 16 is exposed to temperature that is below room temperature. The grooves 46 and the relatively thin side walls 42 allow the cool air to reduce the temperature of the dough at a rate that improves the shelf life of the dough.

Additional trays 16 may be filled in step 111 and in step 112 the dough segments 12 are allowed to rise to conform to the shape of the dough wells 32. As the dough segments 12 expand during proofing, the side walls 42 of the dough wells 32 contain and direct the dough upwards to prevent contact between adjacent dough segments 12.

In step 114 the trays are stacked on top of each other for efficient use of space during transportation. In the example provided the trays are stacked by inserting them into a tub 14 and stacking the tubs 14. It should be appreciated that in alternative embodiments the trays are a single component carrier and may be stacked directly on other trays.

In 116 the trays are transported to their destination. For example, the trays may be transported from the dough production facility to a retail store, such as a bakery or pizzeria. In step 118 the dough segments 12 are removed from the dough wells 32 and used as desired. As described above, the dough wells 32 shape the dough segments 12 during proofing to achieve a desirable dough ball shape that may be used to make a pizza. The trays 16 may then be reused or recycled accordingly.

The description of the invention is merely exemplary in nature and variations that do not depart from the gist of the invention are intended to be within the scope of the invention. Such variations are not to be regarded as a departure from the spirit and scope of the invention.

What is claimed is:

1. A dough carrier comprising:
a polymeric main body; and
a plurality of frustoconical shaped dough wells formed in the main body and each having an open end opposing a closed end, each of the plurality of frustoconical shaped dough wells including;
a bottom portion that is substantially disk shaped, wherein the bottom portion defines the closed end, and
a side wall extending between the bottom portion and the open end, wherein the side wall tapers from a first diameter at the open end to a second diameter at the bottom portion that is less than the first diameter.

2. The dough carrier of claim 1 wherein the side wall defines grooves extending between the open end and the bottom portion of each of the plurality of frustoconical shaped dough wells.

3. The dough carrier of claim 2 wherein troughs of the grooves extend radially outward from the side walls and have a shape that is substantially a portion of a cone that has been cut along a plane from a base of the cone to a tip of the cone.

4. The dough carrier of claim 1 further including a plurality of denesting features.

5. The dough carrier of claim 4 wherein the denesting features include a plurality of ridges extending radially outward from the grooves and including a resting surface that is substantially parallel with the bottom portion and is facing away from the open end.

6. The dough carrier of claim 4 wherein the denesting features include a plurality of denesting lugs extending from the open end towards the bottom portion, wherein the denesting lugs each have a shape that is substantially a rectangular prism.

7. The dough carrier of claim 1 wherein the carrier is comprised of a single injection molded component.

8. The dough carrier of claim 7 wherein the side wall of each of the plurality of dough wells has a predetermined thickness that is preselected to exhibit minimal warping when exposed to hot water and to conduct heat at a rate that quickly reduce a temperature of the dough when the dough carrier is placed in a refrigerated environment.

9. The dough carrier of claim 1 wherein the main body is a vacuum formed tray disposed in an injection molded tub.

10. The dough carrier of claim 1 wherein the side walls include materials that inhibit adhesion with dough.

11. The dough carrier of claim 10 wherein the materials that inhibit adhesion include silicone that is included in a maximum amount considered safe for use with food.

12. The dough carrier of claim 1 wherein each of the plurality of dough wells is sized to contain a pizza dough ball when the pizza dough ball is substantially finished rising.

13. The dough carrier of claim 1 wherein the plurality of dough wells include eleven dough wells arranged in three staggered rows.

14. The dough carrier of claim 1 wherein the plurality of dough wells have a diameter to depth ratio of about 2.5:1.

15. The dough carrier of claim 1 wherein the main body further includes a pair of cutout handle portions defined at opposing ends of the main body.

16. A method of distributing dough, the method comprising:
providing a dough carrier having a plurality of wells for holding the dough;
extruding the dough;
separating the dough into a plurality of dough segments;
inserting the plurality of dough segments into the plurality of wells of the dough carrier;
cooling the dough segments;
allowing the dough segments to rise to conform to the shape of the wells of the dough carrier;
transporting the dough carrier; and
removing the dough from the wells of the dough carrier.

17. The method of claim 16 further comprising filling additional dough carriers and stacking the dough carriers before transporting the dough carrier.

18. The method of claim 16 wherein providing the dough carrier further includes removing the dough carrier from a stack of nested dough carriers.

19. The method of claim 16 wherein inserting the plurality of dough segments into the plurality of wells of the dough carrier further includes inserting the plurality of dough segments into the plurality of wells of the dough carrier with minimal handling of the dough to minimize formation of a skin on the dough.

20. The method of claim 16 wherein providing a dough carrier further includes providing a dough carrier having a plurality of wells each having a plurality of grooves, and wherein cooling the dough segments further includes allowing cool air to travel through the grooves of the wells.

21. The method of claim 16 wherein transporting the dough carrier further includes transporting the dough carrier to a pizzeria.

22. A system for transporting dough, the system comprising:
a dough carrier having a plurality of wells for holding the dough;
a dough extruder for extruding the dough;
a dough separator for separating the dough into dough segments;
a dough inserter to insert the plurality of dough segments into the plurality of wells of the dough carrier;
a cooler for cooling the dough segments in the wells of the dough carrier; and
a vehicle for transporting the dough carrier that contains the dough segments.
